(19) United States
(12) Patent Application Publication
(10) Pub. No.: US 2017/0185898 A1
(43) Pub. Date: Jun. 29, 2017

(54) Technologies for distributed machine learning

(71) Applicants: Arnab Paul, Hillsboro, OR (US); Gautham Chinya, Hillsboro, OR (US)

(72) Inventors: Arnab Paul, Hillsboro, OR (US); Gautham Chinya, Hillsboro, OR (US)

(21) Appl. No.: 14/998,313

(22) Filed: Dec. 26, 2015

(51) Int. Cl. G06N 3/08; H04L 29/08; G06N 99/00

(52) U.S. Cl. CPC G06N 3/088; G06N 99/005; H04L 67/1002

(57) ABSTRACT

Technologies for distributed machine learning include a mobile compute device to identify an input dataset including a plurality of dataset elements for machine learning and select a subset of the dataset elements. The mobile compute device transmits the subset to a cloud server for machine learning and receives, from the cloud server, a set of learned parameters for local data classification in response to transmitting the subset to the cloud server. The learned parameters are based on an expansion of features extracted by the cloud server from the subset of the dataset elements.

### BACKGROUND

Machine learning involves the study of data with one or more algorithms to build a model that may be used to make predictions or decisions based on input data. In some embodiments, machine learning may be employed based on a supervised learning, unsupervised learning, and/or reinforcement learning approach. For example, unsupervised learning algorithms may be employed to analyze a set of training data (e.g., a set of images in a user gallery) to generate one or more models for the classification/categorization of objects of interest such as people, places, faces, facial features, and/or other objects of interest. Generally, such algorithms require a large amount of data, are quite complex, and/or require a significant amount of execution time. Accordingly, machine learning is often offloaded to a cloud computing environment.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for distributed machine learning;

FIG. 2 is a simplified block diagram of at least one embodiment of an environment of a mobile compute device of the system of FIG. 1;

FIG. 3 is a simplified block diagram of at least one embodiment of an environment of a cloud server of the system of FIG. 1;

FIG. 4 is a simplified flow diagram of at least one embodiment of a method for distributed machine learning that may be executed by the mobile compute device of FIG. 2; and

FIG. 5 is a simplified flow diagram of at least one embodiment of a method for distributed machine learning that may be executed by the mobile compute device of FIG. 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

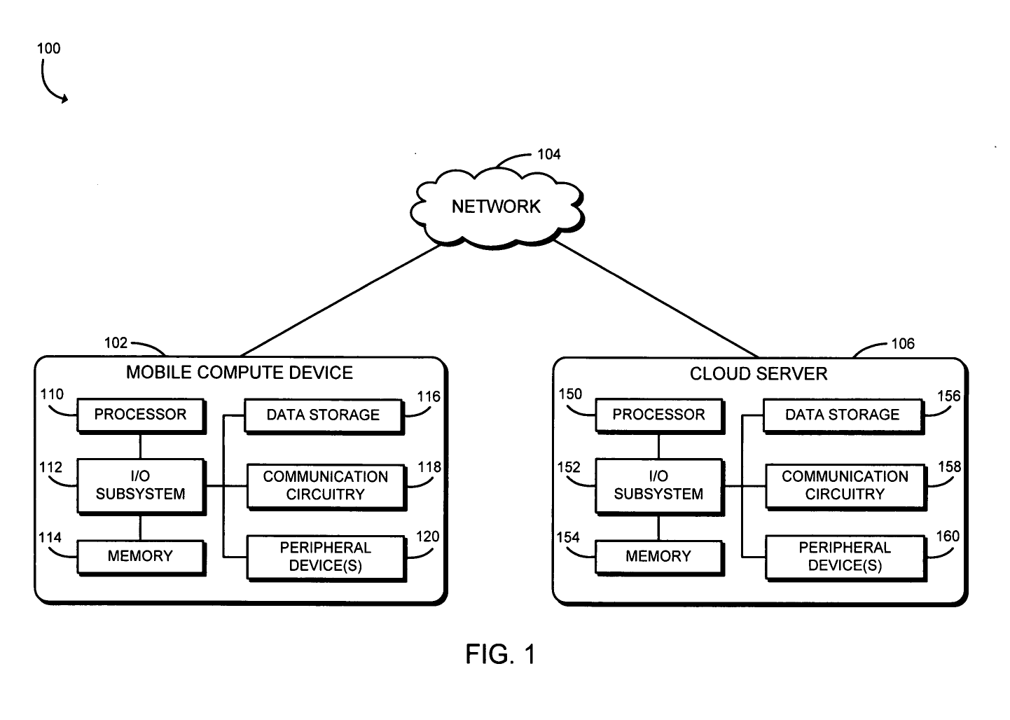

Referring now to FIG. 1, a system 100 for distributed machine learning includes a mobile compute device 102, a network 104, and a cloud server 106. Although only one mobile compute device 102, one network 104, and one cloud server 106 are illustratively shown in FIG. 1, the system 100 may include any number of mobile compute devices 102, networks 104, and/or cloud servers 106 in other embodiments. For example, in some embodiments, multiple mobile compute devices 102 may utilize the cloud server 106 for distributed machine learning.

As described in detail below, in the illustrative embodiment, the mobile compute device 102 selects a subset of a training/input dataset and transmits the subset to the cloud server 106 for feature extraction. As such, the cloud server 106 extracts a feature set from the subset of the training data received from the mobile compute device 102, generates an expanded feature set (e.g., learned parameters) by applying various transformations (e.g., rotational transform) to the various features, and transmits the expanded features set to the mobile compute device 102 for local data classification (e.g., object recognition) on the mobile compute device 102. It should be appreciated that the techniques described herein allow for distributed and offloaded computation back-and-forth between the mobile compute device 102 and the cloud server 106. Further, in some embodiments, the use of a small dataset (i.e., the subset of the training data) is much faster than traditional offloaded machine learning, involves much less networking overhead, and/or may even permit real-time (or near real-time) analysis by the mobile compute device 102. Accordingly, in some embodiments, the cloud server 106 may be utilized as a seamless extension of the mobile compute device 102.

The mobile compute device 102 may be embodied as any type of computing device capable of performing the functions described herein. For example, the mobile compute device 102 may be embodied as a smartphone, cellular phone, wearable computing device, personal digital assistant, mobile Internet device, tablet computer, netbook, notebook, Ultrabook™, laptop computer, and/or any other mobile computing/communication device. Although the mobile compute device 102 is described herein as a mobile device, it should be appreciated that the compute device 102 may be “stationary” in some embodiments. For example, in some embodiments, the compute device 102 may be embodied as a stationary compute device with limited computational resources.

As shown in FIG. 1, the illustrative mobile compute device 102 includes a processor 110, an input/output (“I/O”) subsystem 112, a memory 114, a data storage 116, a communication circuitry 118, and one or more peripheral devices 120. Of course, the mobile compute device 102 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component. For example, the memory 114, or portions thereof, may be incorporated in the processor 110 in some embodiments.

The processor 110 may be embodied as any type of processor capable of performing the functions described herein. For example, the processor 110 may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the mobile compute device 102 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the mobile compute device 102. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and other components of the mobile compute device 102, on a single integrated circuit chip.

The data storage 116 may be embodied as any type of device or devices configured for short-term or long-term storage of data such as, for example, memory devices and circuits, memory cards, hard disk drives, solid-state drives, or other data storage devices. The data storage 116 and/or the memory 114 may store various data during operation of the mobile compute device 102 as described herein.

The communication circuitry 118 may be embodied as any communication circuit, device, or collection thereof, capable of enabling communications between the mobile compute device 102 and other remote devices (e.g., the cloud server 106) over a network (e.g., the network 104). The communication circuitry 118 may be configured to use any one or more communication technologies (e.g., wireless or wired communications) and associated protocols (e.g., Ethernet, Bluetooth®, Wi-Fi®, WiMAX, LTE, 5G, etc.) to effect such communication.

The peripheral devices 120 may include any number of additional peripheral or interface devices, such as speakers, microphones, additional storage devices, and so forth. The particular devices included in the peripheral devices 120 may depend on, for example, the type and/or intended use of the mobile compute device 102.

The network 104 may be embodied as any type of communication network capable of facilitating communication between the mobile compute device 102 and remote devices (e.g., the cloud server 106). As such, the network 104 may include one or more networks, routers, switches, computers, and/or other intervening devices. For example, each network 104 may be embodied as or otherwise include one or more cellular networks, telephone networks, local or wide area networks, publicly available global networks (e.g., the Internet), an ad hoc network, or any combination thereof.

The cloud server 106 may be embodied as any type of computing device capable of performing the functions described herein. For example, in some embodiments, the cloud server 106 may be embodied as a server, rack-mounted server, blade server, desktop computer, laptop computer, tablet computer, notebook, netbook, Ultrabook™, cellular phone, smartphone, personal digital assistant, mobile Internet device, wearable computing device, Hybrid device, and/or any other computing/communication device. As shown in FIG. 1, the illustrative cloud server 106 includes a processor 150, an I/O subsystem 152, a memory 154, a data storage 156, a communication circuitry 158, and one or more peripheral devices 160. Each of the processor 150, the I/O subsystem 152, the memory 154, the data storage 156, the communication circuitry 158, and/or the peripheral devices 160 may be similar to the corresponding components of the mobile compute device 102. As such, the description of those components of the mobile compute device 102 is equally applicable to the described of those components of the cloud server 106 and is not repeated herein for clarity of the description.

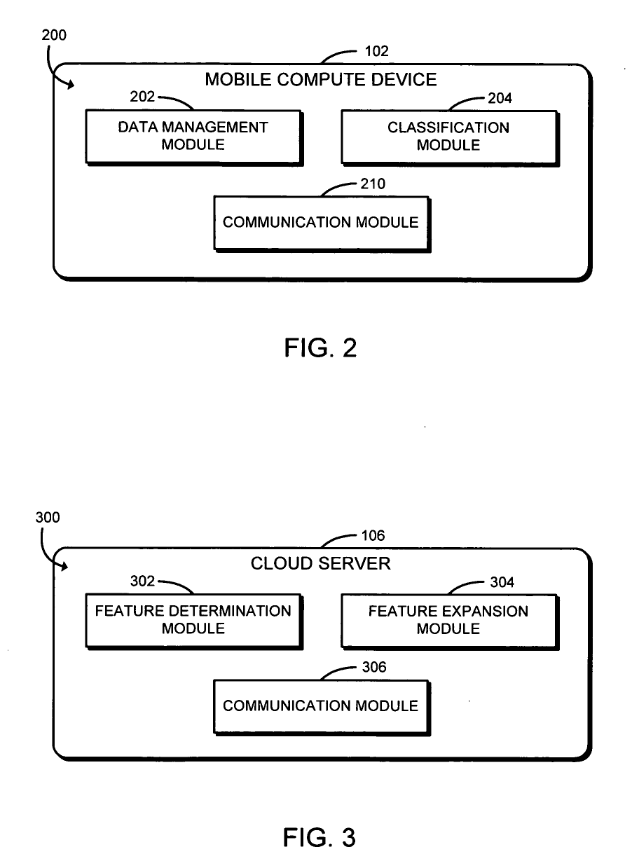

Referring now to FIG. 2, in use, the mobile compute device 102 establishes an environment 200 for distributed machine learning. The illustrative environment 200 includes a data management module 202, a classification module 204, and a communication module 206. The various modules of the environment 200 may be embodied as hardware, software, firmware, or a combination thereof. For example, the various modules, logic, and other components of the environment 200 may form a portion of, or otherwise be established by, the processor 110 or other hardware components of the mobile compute device 102. As such, in some embodiments, one or more of the modules of the environment 200 may be embodied as circuitry or collection of electrical devices (e.g., a data management circuitry, a classification circuitry, and/or a communication circuitry). Additionally, in some embodiments, one or more of the illustrative modules may form a portion of another module and/or one or more of the illustrative modules may be independent of one another.

The data management module 202 is configured to manage the training/input data used for machine learning (e.g., pattern/object recognition). In particular, in the illustrative embodiment, the data management module 202 identifies the input/training dataset and selects a subset of the input/training dataset (i.e., a subset of the dataset elements) for transmission to the cloud server 106. In some embodiments, the subset may include a small number of elements relative to the number of elements in the entire input/training dataset. Depending on the particular embodiment, the subset may be selected randomly or according to a pre-defined pattern. As described below, in the illustrative embodiment, the training/input dataset is a set of images (e.g., an image gallery). In some embodiments, the images may depict various objects of interest (e.g., for object recognition/classification). In other embodiments, the dataset may include other types of data such as, for example, audio data/signals and/or other suitable data for performing the functions described herein.

The classification module 204 is configured to perform local classification of various dataset elements based on learned parameters received from the cloud server 106. In some embodiments, the learned parameters of the cloud server 106 may serve as a model for classification of a particular data elements in a dataset. For example, in embodiments in which images are analyzed and the learned parameters are associated with images, the classification module 204 may perform local classification to recognize a particular object (e.g., a person, face, facial feature, or other object of interest) in one or more images of the analyzed dataset.

The communication module 206 handles the communication between the mobile compute device 102 and other computing devices of the system 100 (e.g., the cloud server 106). For example, as described herein, the mobile compute device 102 may transmit the subset of the input/training dataset to the cloud server 106 and receive a set of learned parameters for local data classification based on an analysis of the subset by the cloud server 106. As described below, the learned parameters are based on an expansion of features extracted by the cloud server 106 from the subset of data elements. In particular, the cloud server 106 applies one or more transformations to the various features extracted from the subset to generate the expanded set of features to send back to the mobile compute device 102 for classification. In some embodiments, the mobile compute device 102 may receive the set of learned parameters for local data classification in response to transmitting the subset to the cloud server 106 in real-time or near real-time (e.g., due to networking and computational efficiencies associated with the subset being used for feature extraction rather than the entire dataset).

In some embodiments, the classification module 204 may be “retrained” with the expanded feature set provided by the cloud server 106. For example, in some embodiments, the training may be performed on the full dataset available on the mobile compute device 102; however, because the expanded feature set may include most of the important “building blocks,” the training may focus (e.g., only) on “classification” aspects (e.g., not feature learning) and may result in a significantly faster performance. It should be appreciated that such training may be performed utilize various different training schemes including, for example, Support Vector Machine (SVM) training.

Referring now to FIG. 3, in use, the cloud server 106 establishes an environment 300 for distributed machine learning. The illustrative environment 300 includes a feature determination module 302, a feature expansion module 304, and a communication module 306. The various modules of the environment 300 may be embodied as hardware, software, firmware, or a combination thereof. For example, the various modules, logic, and other components of the environment 300 may form a portion of, or otherwise be established by, the processor 150 or other hardware components of the cloud server 106. As such, in some embodiments, one or more of the modules of the environment 300 may be embodied as circuitry or collection of electrical devices (e.g., a feature determination circuitry, a feature expansion circuitry, and/or a communication circuitry). Additionally, in some embodiments, one or more of the illustrative modules may form a portion of another module and/or one or more of the illustrative modules may be independent of one another.

The feature determination module 302 is configured to extract or otherwise identify/determine one or more features from a dataset received from the mobile compute device 102. It should be appreciated that the feature determination module 302 may utilize any algorithms, techniques, and/or mechanisms suitable for doing so. It should further be appreciated that the particular features may vary depending, for example, on the type of data being analyzed (e.g., image/video data, audio data, topological/geological data, etc.). In some image-based embodiments, the features may be identified or determined in such a way as to enable the classification/recognition of one or more objects of interest in the images. As indicated above, in the illustrative embodiment, the feature determination module 302 is configured to determine the features based on a subset of the training/input data of the mobile compute device 102.

The feature expansion module 304 is configured to generate an expanded feature set based on the one or more features extracted/identified by the feature determination module 302. In particular, the feature expansion module 304 may determine/identify one or more transformations to apply to one or more of the extracted features (e.g., to apply to each feature) and apply the transformation(s) to the extracted features to generate additional features. The particular transformations applied may vary depending on the particular embodiment and, for example, the type of data analyzed (e.g., image data, audio data, etc.). For example, in embodiments involving images, the transformations may include rotational transformations, perspective transformations, transformations associated with image illumination (or scene lighting, etc.), and/or other suitable image transformations. In some embodiments, the feature expansion module 304 may discretize the space of the transforms into a finite number of transforms. For example, the space of all two-dimensional rotations is a continuous space (i.e., with infinite amounts of rotation) but may be discretized to sufficiently describe the possible rotational variations (e.g., 10 degrees, 20 degrees, 30 degrees, and other 10-degree increments up to 360 degrees). In some embodiments, although the number of elements in the subset and/or the extracted features may be small in number, the number of transformations applied to the extracted features may be much greater in number. As such, the feature expansion module 304 may “blow up” or significantly expand the feature dictionary by virtue of the applied transformations.

The communication module 306 handles the communication between the cloud server 106 and other computing devices of the system 100 (e.g., the mobile compute device 102). For example, as described herein, the cloud server 106 may receive the subset of the training/input dataset from the mobile compute device 102 and transmit the expanded feature set back to the mobile compute device 102 as learned parameters for data classification.

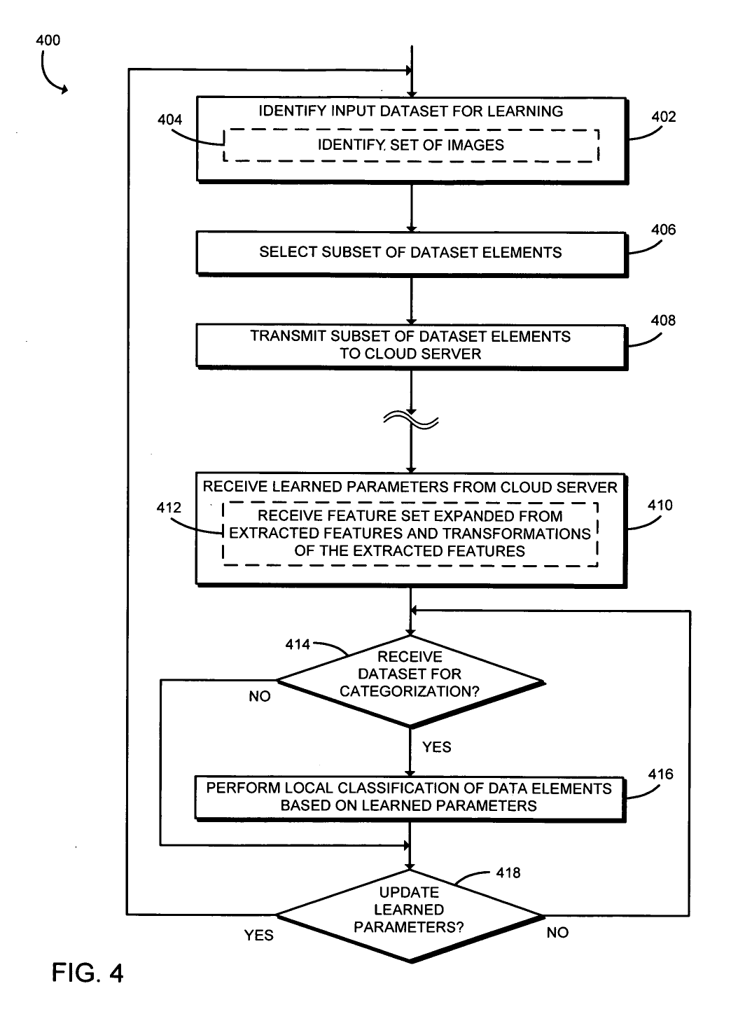

Referring now to FIG. 4, in use, the mobile compute device 102 may execute a method 400 for distributed machine learning. The illustrative method 400 begins with block 402 in which the mobile compute device 102 identifies an input/training dataset for machine learning. In particular, in some embodiments, the mobile compute device 102 may identify a set of images in block 404. However, as discussed above, the mobile compute device 102 may identify a dataset of another data type (e.g., audio data, topological/geographical data, etc.). In block 406, the mobile compute device 102 selects a subset of the dataset elements. It should be appreciated that the mobile compute device 102 may select the subset using any suitable technique, mechanism, and/or algorithm. For example, in some embodiments, the subset may be a random selection of the dataset elements. In the illustrative embodiment, the mobile compute device 102 selects a small number of data elements for the subset relative to the total number of dataset elements; however, the number of data elements included in the subset may vary depending on the particular embodiment. In block 408, the mobile compute device 102 transmits the subset of dataset elements to the cloud server 108 for feature extraction and feature set expansion as described below.

As described herein, the cloud server 106 extracts the features and generates an expanded feature set for use by the mobile compute device 102 as learned parameters for machine learning (e.g., object classification/recognition). Accordingly, in block 410, the mobile compute device 102 receives the learned parameters from the cloud server 106. In particular, in block 412, the mobile compute device 102 may receive the feature set expanded by the cloud server 106 from the extracted features and transformations of the extracted features.

In block 414, the mobile compute device 102 determines whether a dataset for classification has been received or retrieved. In other words, the mobile compute device 102 determines whether a dataset to which the learned parameters are to be applied has been received or retrieved by the mobile compute device 102. If so, in block 416, the mobile compute device 102 performs local classification of the data elements of that dataset based on the learned parameters. For example, in some embodiments, the mobile compute device 102 may analyze various images to determine whether an object of interest can be identified within the images. In block 418, the mobile compute device 102 determines whether to update the learned parameters. If not, the method 400 returns to block 414 in which the mobile compute device 102 determines whether a dataset for classification has been received or retrieved. That is, the mobile compute device 102 may wait until there is a dataset available for analysis based on the learned parameters. However, if the mobile compute device 102 determines to update the learned parameters, the method 400 returns to block 402 in which the mobile compute device 102 identifies the input/training dataset for learning. In other words, in some embodiments, the system 100 may periodically update the set of learned parameters based on a selection of new dataset elements and feature set extraction/expansion based on the new dataset elements. For example, in some embodiments, the mobile compute device 102 may determine to update the learned parameters based on new objects of interest and/or significant changes to the input/training dataset.

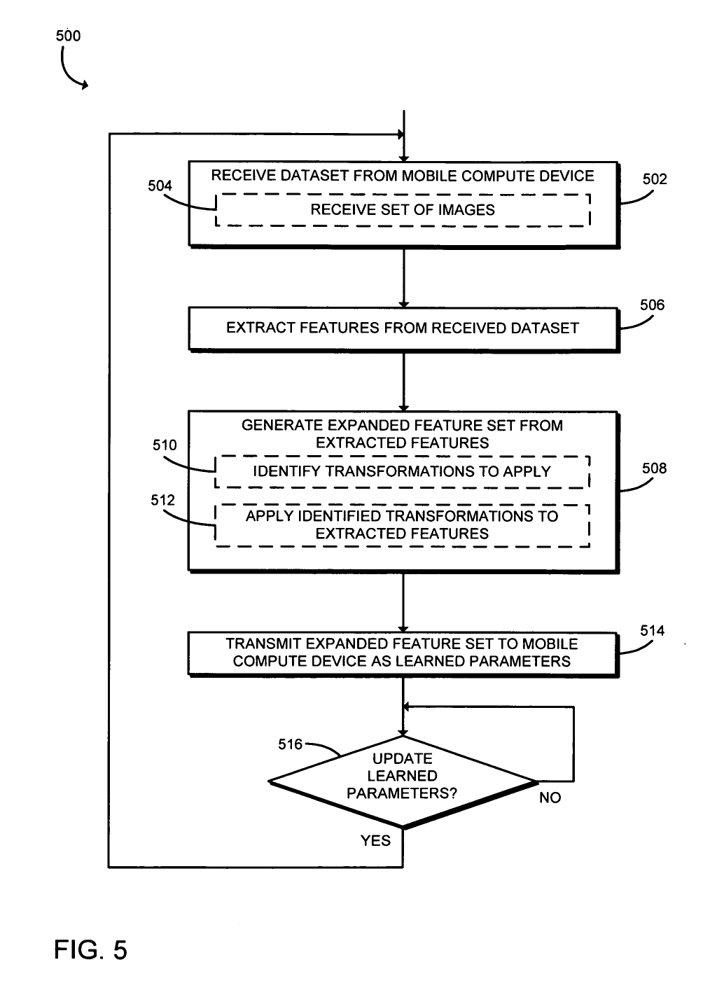

Referring now to FIG. 5, in use, the cloud server 106 may execute a method 500 for distributed machine learning. The illustrative method 500 begins with block 502 in which the cloud server 106 receives a dataset from the mobile compute device 102 for distributed machine learning. For example, in block 504, the cloud server 106 may receive a set of images. As indicated above, the cloud server 106 may receive a subset of the training/input dataset identified by the mobile compute device 102. In block 506, the cloud server 106 extracts or learns one or more features from the received dataset. As indicated above, it should be appreciated that the cloud server 106 may utilize any algorithms, techniques, and/or mechanisms suitable for doing so. Further, the particular features extracted may vary depending on the particular type of data being analyzed (e.g., image/video data, audio data, topological/geological data, etc.). In the illustrative embodiment, the learned features may be included in a feature dictionary.

In block 508, the cloud server 106 generates an expanded feature set/dictionary from the extracted features. In doing so, the cloud server 106 may identify one or more transformations to apply to the extracted features in block 510 and apply the identified transformations to the extracted features in block 512. The particular transformations applied may vary depending on the particular embodiment and, for example, the type of data analyzed (e.g., image data, audio data, etc.). For example, in some embodiments, the transformations may include rotational transformations, perspective transformations, transformations associated with image illumination (or scene lighting, etc.), and/or other suitable image transformations. Further, as described above, in determining the particular transformations, the cloud server 106 may discretize a particular type of transformation (e.g., image rotation) with an infinite number of possible parameter values (e.g., between zero and 360 degrees) to determine a finite number of transformations to utilize of that particular transformation type.

In block 514, the cloud server 106 transmits the expanded feature set to the mobile compute device 102 as learned parameters for use in data classification. In block 516, the cloud server 106 determines whether to update the learned parameters. If so, the method 500 returns to block 502 in which the cloud server 106 receives another dataset (e.g., a different subset of the input/training data) from the mobile compute device 102. In other words, in some embodiments, the system 100 may periodically update the set of learned parameters based on a selection of new dataset elements and feature set extraction/expansion based on the new dataset elements.

### EXAMPLES

Illustrative examples of the technologies disclosed herein are provided below. An embodiment of the technologies may include any one or more, and any combination of, the examples described below.

Example 1 includes a mobile compute device for distributed machine learning, the mobile compute device comprising a data management module to (i) identify an input dataset including a plurality of dataset elements for machine learning and (ii) select a subset of the dataset elements; and a communication module (i) transmit the subset to a cloud server for machine learning and (ii) receive, from the cloud server, a set of learned parameters for local data classification in response to transmittal of the subset to the cloud server, wherein the learned parameters are based on an expansion of features extracted by the cloud server from the subset of the dataset elements.

Example 2 includes the subject matter of Example 1, and wherein to identify the input dataset comprises to identify a set of images for classification.

Example 3 includes the subject matter of any of Examples 1 and 2, and wherein the learned parameters include one or more transformations of the features extracted by the cloud server.

Example 4 includes the subject matter of any of Examples 1-3, and further including a classification module to perform local classification of dataset elements based on the learned parameters.

Example 5 includes the subject matter of any of Examples 1-4, and wherein each of the dataset elements comprises an image; and wherein to perform the local classification comprises to recognize a particular object in one or more images based on the learned parameters.

Example 6 includes the subject matter of any of Examples 1-5, and wherein to receive the set of learned parameters comprises to receive a set of learned parameters for local data classification in response to transmittal of the subset to the cloud server in real-time.

Example 7 includes the subject matter of any of Examples 1-6, and wherein the communication module is to periodically update the set of learned parameters based on a selection of a new subset of the dataset elements, transmittal of the new subset to the cloud server, and receipt of an updated set of learned parameters from the cloud server.

Example 8 includes the subject matter of any of Examples 1-7, and wherein to select the subset of the dataset elements comprises to select a random sample of the dataset elements.

Example 9 includes a method for distributed machine learning by a mobile compute device, the method comprising identifying, by the mobile compute device, an input dataset including a plurality of dataset elements for machine learning; selecting, by the mobile compute device, a subset of the dataset elements; transmitting, by the mobile compute device, the subset to a cloud server for machine learning; and receiving, by the mobile compute device and from the cloud server, a set of learned parameters for local data classification in response to transmitting the subset to the cloud server, wherein the learned parameters are based on an expansion of features extracted by the cloud server from the subset of the dataset elements.

Example 10 includes the subject matter of Example 9, and wherein identifying the input dataset comprises identifying a set of images for classification.

Example 11 includes the subject matter of any of Examples 9 and 10, and wherein the learned parameters include one or more transformations of the features extracted by the cloud server.

Example 12 includes the subject matter of any of Examples 9-11, and further including performing, by the mobile compute device, local classification of dataset elements based on the learned parameters.

Example 13 includes the subject matter of any of Examples 9-12, and wherein each of the dataset elements comprises an image; and wherein performing the local classification comprises recognizing a particular object in one or more images based on the learned parameters.

Example 14 includes the subject matter of any of Examples 9-13, and wherein receiving the set of learned parameters comprises receiving a set of learned parameters for local data classification in response to transmitting the subset to the cloud server in real-time.

Example 15 includes the subject matter of any of Examples 9-14, and further including periodically updating, by the mobile compute device, the set of learned parameters based on a selection of a new subset of the dataset elements, transmittal of the new subset to the cloud server, and receipt of an updated set of learned parameters from the cloud server.

Example 16 includes the subject matter of any of Examples 9-15, and wherein selecting the subset of the dataset elements comprises selecting a random sample of the dataset elements.

Example 17 includes a computing device comprising a processor; and a memory having stored therein a plurality of instructions that when executed by the processor cause the computing device to perform the method of any of Examples 9-16.

Example 18 includes one or more machine-readable storage media comprising a plurality of instructions stored thereon that in response to being executed result in a computing device performing the method of any of Examples 9-16.

Example 19 includes a computing device comprising means for performing the method of any of Examples 9-16.

Example 20 includes a cloud server for distributed machine learning, the cloud server comprising a communication module to receive a dataset from a mobile compute device; a feature determination module to extract one or more features from the received dataset; and a feature expansion module to generate an expanded feature set based on the one or more extracted features; wherein the communication module is further to transmit the expanded feature set to the mobile compute device as learned parameters for data classification.

Example 21 includes the subject matter of Example 20, and wherein to generate the expanded feature set comprises to identify one or more transformations to apply to the extracted features; and apply the one or more identified transformations to each of the extracted features to generate one or more additional features for each of the extracted features.

Example 22 includes the subject matter of any of Examples 20 and 21, and wherein the dataset comprises a set of images; and wherein the one or more transformations comprise at least one of a rotational transformation or a perspective transformation.

Example 23 includes the subject matter of any of Examples 20-22, and wherein the dataset comprises a set of images; and wherein the one or more transformations comprise a transformation associated with an illumination of a corresponding image.

Example 24 includes the subject matter of any of Examples 20-23, and wherein to identify one or more transformations comprises to identify a type of transformation to apply to the extracted features; and discretize a space of the type transformations to identify a finite number of transformations of the type of transformations to apply.

Example 25 includes the subject matter of any of Examples 20-24, and wherein the dataset received from the mobile compute device consists of a random subset of data elements extracted by the mobile compute device from a data superset.

Example 26 includes the subject matter of any of Examples 20-25, and wherein to transmit the expanded feature set comprises to transmit the expanded feature set to the mobile compute device in response to receipt of the dataset from the mobile compute device in real-time.

Example 27 includes a method for distributed machine learning by a cloud server, the method comprising receiving, by the cloud server, a dataset from the mobile compute device; extracting, by the cloud server, one or more features from the received dataset; generating, by the cloud server, an expanded feature set based on the one or more extracted features; and transmitting, by the cloud server, the expanded feature set to the mobile compute device as learned parameters for data classification.

Example 28 includes the subject matter of Example 27, and wherein generating the expanded feature set comprises identifying one or more transformations to apply to the extracted features; and applying the one or more identified transformations to each of the extracted features to generate one or more additional features for each of the extracted features.

Example 29 includes the subject matter of any of Examples 27 and 28, and wherein the dataset comprises a set of images; and wherein the one or more transformations comprise at least one of a rotational transformation or a perspective transformation.

Example 30 includes the subject matter of any of Examples 27-29, and wherein the dataset comprises a set of images; and wherein the one or more transformations comprise a transformation associated with an illumination of a corresponding image.

Example 31 includes the subject matter of any of Examples 27-30, and wherein identifying one or more transformations comprises identifying a type of transformation to apply to the extracted features; and discretizing a space of the type transformations to identify a finite number of transformations of the type of transformations to apply.

Example 32 includes the subject matter of any of Examples 27-31, and wherein the dataset received from the mobile compute device consists of a random subset of data elements extracted by the mobile compute device from a data superset.

Example 33 includes the subject matter of any of Examples 27-32, and wherein transmitting the expanded feature set comprises transmitting the expanded feature set to the mobile compute device in response to receiving the dataset from the mobile compute device in real-time.

Example 34 includes a computing device comprising a processor; and a memory having stored therein a plurality of instructions that when executed by the processor cause the computing device to perform the method of any of Examples 27-33.

Example 35 includes one or more machine-readable storage media comprising a plurality of instructions stored thereon that in response to being executed result in a computing device performing the method of any of Examples 27-33.

Example 36 includes a computing device comprising means for performing the method of any of Examples 27-33.

Example 37 includes a mobile compute device for distributed machine learning, the mobile compute device comprising means for identifying an input dataset including a plurality of dataset elements for machine learning; means for selecting a subset of the dataset elements; means for transmitting the subset to a cloud server for machine learning; and means for receiving, from the cloud server, a set of learned parameters for local data classification in response to transmitting the subset to the cloud server, wherein the learned parameters are based on an expansion of features extracted by the cloud server from the subset of the dataset elements.

Example 38 includes the subject matter of Example 37, and wherein the means for identifying the input dataset comprises means for identifying a set of images for classification.

Example 39 includes the subject matter of any of Examples 37 and 38, and wherein the learned parameters include one or more transformations of the features extracted by the cloud server.

Example 40 includes the subject matter of any of Examples 37-39, and further including means for performing local classification of dataset elements based on the learned parameters.

Example 41 includes the subject matter of any of Examples 37-40, and wherein each of the dataset elements comprises an image; and wherein the means for performing the local classification comprises means for recognizing a particular object in one or more images based on the learned parameters.

Example 42 includes the subject matter of any of Examples 37-41, and wherein the means for receiving the set of learned parameters comprises means for receiving a set of learned parameters for local data classification in response to transmittal of the subset to the cloud server in real-time.

Example 43 includes the subject matter of any of Examples 37-42, and further including means for periodically updating the set of learned parameters based on a selection of a new subset of the dataset elements, transmittal of the new subset to the cloud server, and receipt of an updated set of learned parameters from the cloud server.

Example 44 includes the subject matter of any of Examples 37-43, and wherein the means for selecting the subset of the dataset elements comprises means for selecting a random sample of the dataset elements.

Example 45 includes a cloud server for distributed machine learning, the cloud server comprising means for receiving a dataset from the mobile compute device; means for extracting one or more features from the received dataset; means for generating an expanded feature set based on the one or more extracted features; and means for transmitting the expanded feature set to the mobile compute device as learned parameters for data classification.

Example 46 includes the subject matter of Example 45, and wherein the means for generating the expanded feature set comprises means for identifying one or more transformations to apply to the extracted features; and means for applying the one or more identified transformations to each of the extracted features to generate one or more additional features for each of the extracted features.

Example 47 includes the subject matter of any of Examples 45 and 46, and wherein the dataset comprises a set of images; and wherein the one or more transformations comprise at least one of a rotational transformation or a perspective transformation.

Example 48 includes the subject matter of any of Examples 45-47, and wherein the dataset comprises a set of images; and wherein the one or more transformations comprise a transformation associated with an illumination of a corresponding image.

Example 49 includes the subject matter of any of Examples 45-48, and wherein the means for identifying one or more transformations comprises means for identifying a type of transformation to apply to the extracted features; and means for discretizing a space of the type transformations to identify a finite number of transformations of the type of transformations to apply.

Example 50 includes the subject matter of any of Examples 45-49, and wherein the dataset received from the mobile compute device consists of a random subset of data elements extracted by the mobile compute device from a data superset.

Example 51 includes the subject matter of any of Examples 45-50, and wherein the means for transmitting the expanded feature set comprises means for transmitting the expanded feature set to the mobile compute device in response to receipt of the dataset from the mobile compute device in real-time.

1. A mobile compute device for distributed machine learning, the mobile compute device comprising:
a data management module to (i) identify an input dataset including a plurality of dataset elements for machine learning and (ii) select a subset of the dataset elements; and
a communication module (i) transmit the subset to a cloud server for machine learning and (ii) receive, from the cloud server, a set of learned parameters for local data classification in response to transmittal of the subset to the cloud server,
wherein the learned parameters are based on an expansion of features extracted by the cloud server from the subset of the dataset elements.

2. The mobile compute device of claim 1, wherein to identify the input dataset comprises to identify a set of images for classification.

3. The mobile compute device of claim 1, wherein the learned parameters include one or more transformations of the features extracted by the cloud server.

4. The mobile compute device of claim 1, further comprising a classification module to perform local classification of dataset elements based on the learned parameters.

5. The mobile compute device of claim 4, wherein each of the dataset elements comprises an image; and
wherein to perform the local classification comprises to recognize a particular object in one or more images based on the learned parameters.

6. The mobile compute device of claim 1, wherein to receive the set of learned parameters comprises to receive a set of learned parameters for local data classification in response to transmittal of the subset to the cloud server in real-time.

7. The mobile compute device of claim 1, wherein the communication module is to periodically update the set of learned parameters based on a selection of a new subset of the dataset elements, transmittal of the new subset to the cloud server, and receipt of an updated set of learned parameters from the cloud server.

8. The mobile compute device of claim 1, wherein to select the subset of the dataset elements comprises to select a random sample of the dataset elements.

9. One or more machine-readable storage media comprising a plurality of instructions stored thereon that, in response to execution by a mobile compute device, cause the mobile compute device to:
identify an input dataset including a plurality of dataset elements for machine learning;
select a subset of the dataset elements;
transmit the subset to a cloud server for machine learning; and
receive, from the cloud server, a set of learned parameters for local data classification in response to transmittal of the subset to the cloud server, wherein the learned parameters are based on an expansion of features extracted by the cloud server from the subset of the dataset elements.

10. The one or more machine-readable storage media of claim 9, wherein to identify the input dataset comprises to identify a set of images for classification.

11. The one or more machine-readable storage media of claim 9, wherein the learned parameters include one or more transformations of the features extracted by the cloud server.

12. The one or more machine-readable storage media of claim 9, wherein the plurality of instructions further cause the mobile compute device to perform local classification of dataset elements based on the learned parameters.

13. The one or more machine-readable storage media of claim 12, wherein each of the dataset elements comprises an image; and
wherein to perform the local classification comprises to recognize a particular object in one or more images based on the learned parameters.

14. The one or more machine-readable storage media of claim 9, wherein the plurality of instructions further cause the mobile compute device to periodically update the set of learned parameters based on a selection of a new subset of the dataset elements, transmittal of the new subset to the cloud server, and receipt of an updated set of learned parameters from the cloud server.

15. The one or more machine-readable storage media of claim 9, wherein to select the subset of the dataset elements comprises to select a random sample of the dataset elements.

16. A cloud server for distributed machine learning, the cloud server comprising:
a communication module to receive a dataset from a mobile compute device;
a feature determination module to extract one or more features from the received dataset; and
a feature expansion module to generate an expanded feature set based on the one or more extracted features;
wherein the communication module is further to transmit the expanded feature set to the mobile compute device as learned parameters for data classification.

17. The cloud server of claim 16, wherein to generate the expanded feature set comprises to:
identify one or more transformations to apply to the extracted features; and
apply the one or more identified transformations to each of the extracted features to generate one or more additional features for each of the extracted features.

18. The cloud server of claim 17, wherein the dataset comprises a set of images; and
wherein the one or more transformations comprise at least one of a rotational transformation or a perspective transformation.

19. The cloud server of claim 17, wherein the dataset comprises a set of images; and
wherein the one or more transformations comprise a transformation associated with an illumination of a corresponding image.

20. The cloud server of claim 17, wherein to identify one or more transformations comprises to:
identify a type of transformation to apply to the extracted features; and
discretize a space of the type transformations to identify a finite number of transformations of the type of transformations to apply.

21. One or more machine-readable storage media comprising a plurality of instructions stored thereon that, in response to execution by a cloud server, cause the cloud server to:
receive a dataset from the mobile compute device;
extract one or more features from the received dataset;
generate an expanded feature set based on the one or more extracted features; and
transmit the expanded feature set to the mobile compute device as learned parameters for data classification.

22. The one or more machine-readable storage media of claim 21, wherein to generate the expanded feature set comprises to:
identify one or more transformations to apply to the extracted features; and
apply the one or more identified transformations to each of the extracted features to generate one or more additional features for each of the extracted features.

23. The one or more machine-readable storage media of claim 22, wherein the dataset comprises a set of images; and
wherein the one or more transformations comprise at least one of a rotational transformation or a perspective transformation.

24. The one or more machine-readable storage media of claim 22, wherein to identify one or more transformations comprises to:
identify a type of transformation to apply to the extracted features; and
discretize a space of the type transformations to identify a finite number of transformations of the type of transformations to apply.

25. The one or more machine-readable storage media of claim 21, wherein the dataset received from the mobile compute device consists of a random subset of data elements extracted by the mobile compute device from a data superset.
